(19) United States
(12) Patent Application Publication
(10) Pub. No.: US 2014/0238040 A1
(43) Pub. Date: Aug. 28, 2014

(54) COMBINED CYCLE POWER PLANT

(71) Applicant: Rolls-Royce Corporation, Indianapolis, IN (US)

(72) Inventor: Robert T. DUGE, Carmel, IN (US)

(73) Assignee: Rolls-Royce Corporation, Indianapolis, IN (US)

(21) Appl. No.: 14/133,082

(22) Filed: Dec. 18, 2013

Related U.S. Application Data
(60) Provisional application No. 61/768,511, filed on Feb. 24, 2013.

(51) Int. Cl. F02C 7/275

(52) U.S. Cl. CPC F02C 7/275
USPC 60/778; 60/788

(57) ABSTRACT

A combined cycle engine is used to provide power to a vehicle. In one form the combined cycle engine includes two engines coupled through a gearbox. The engines can include a gas turbine engine, reciprocating engine, and a rotary engine. In one embodiment the combined cycle engine includes a gas turbine engine coupled to a gearbox along with either a reciprocating or rotary engine also coupled to the gearbox. One or more clutches can be provided to selectively couple the gas turbine engine and the reciprocating or rotary engine to the vehicle through the gearbox. In one embodiment the diesel engine can provide power to the vehicle during an idle condition and then also provide power to the gas turbine engine to assist the starting of the gas turbine engine.

### CROSS-REFERENCE TO RELATED APPLICATIONS

This application claims priority to U.S. Provisional Application Ser. No. 61/768,511, entitled “Combined Cycle Power Plant,” filed Feb. 24, 2013, which is incorporated herein by reference in its entirety.

### TECHNICAL FIELD

The present invention generally relates to combined cycle power plants, and more particularly, but not exclusively, to combined cycle power plants configured to provide power during select modes of operation.

### BACKGROUND

Providing combined cycle power plants capable of delivering flexibility of power deliver to a vehicle remains an area of interest. Some existing systems have various shortcomings relative to certain applications. Accordingly, there remains a need for further contributions in this area of technology.

### SUMMARY

One embodiment of the present invention is a unique combined cycle power plant. Other embodiments include apparatuses, systems, devices, hardware, methods, and combinations for providing power delivery from combined cycle power plants. Further embodiments, forms, features, aspects, benefits, and advantages of the present application shall become apparent from the description and figures provided herewith.

### BRIEF DESCRIPTION OF THE FIGURES

FIG. 1 depicts one embodiment of a combined cycle powerplant.

FIG. 2 depicts one embodiment of an engine.

FIG. 3 depicts one embodiment of an engine.

FIG. 4 depicts one embodiment of the application.

### DETAILED DESCRIPTION OF THE ILLUSTRATIVE EMBODIMENTS

For the purposes of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates.

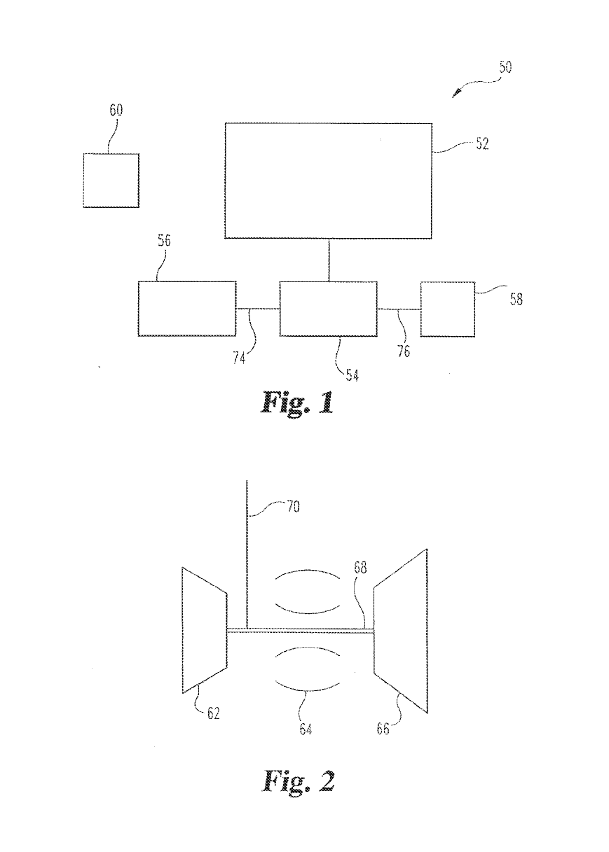

With reference to FIG. 1, a combined cycle power plant 50 is depicted that is useful to provide mechanical and/or electrical power to a vehicle 52. The vehicle can be a ground based vehicle capable of moving along a terrain by rotation of a motive device such as but not limited to a wheel, tire, or tread. In some forms the vehicles are used by the military to transport troops or are platforms from which to discharge weapons. To set forth just a few non-limiting examples, the vehicle can be a vehicle having tires such as a car, van, tractor, etc. The vehicle can also be a tank, truck, personnel carrier, and amphibious vehicle, to set forth just a few more examples. The combined cycle power plant 50 can include a gearbox 54 which is configured to selectively provide power from engines 56 and 58 as will be described further below. The combined cycle power plant can be controlled by a controller 60 which in one form is configured to accept commands from an operator, but in another form can be configured to accept commands from an autonomous device. The controller 60 can be situated in any variety of locations, such as on or about the vehicle 52 including integrated with the power plant 50. Many different configurations are contemplated for the control of the combined cycle power plant 50.

The controller 60 is provided to monitor and control engine operations. The controller 60 can be comprised of digital circuitry, analog circuitry, or a hybrid combination of both of these types. Also, the controller 60 can be programmable, an integrated state machine, or a hybrid combination thereof. The controller 60 can include one or more Arithmetic Logic Units (ALUs), Central Processing Units (CPUs), memories, limiters, conditioners, filters, format converters, or the like which are not shown to preserve clarity. In one form, the controller 60 is of a programmable variety that executes algorithms and processes data in accordance with operating logic that is defined by programming instructions (such as software or firmware). Alternatively or additionally, operating logic for the controller 60 can be at least partially defined by hardwired logic or other hardware. In one particular form, the controller 60 is configured to operate as a Full Authority Digital Engine Control (FADEC); however, in other embodiments it may be organized/configured in a different manner as would occur to those skilled in the art. It should be appreciated that controller 60 can be exclusively dedicated to control of the combined cycle power plant, but in some forms can be configured to control one or more alternative systems of the vehicle 52.

The engines 56 and 58 can take a variety of forms. In one embodiment depicted in FIG. 2, an engine can take the form of a gas turbine engine having a compressor 62, combustor 64, and turbine 66. Though the engine is shown as a single spool having a single shaft 68, but in other embodiments the engine can be a multi-spool engine. The gas turbine engine can take a variety of forms such as a turbofan, turboprop, and turboshaft engine. In some forms the gas turbine engine can include a power take off shaft 70 driven by the shaft 68. In those embodiments having multiple spools, the power take off shaft 70 can be driven by any of the spools.

In one form the gearbox 54 (shown in FIG. 1) can be integrated with the engine depicted in FIG. 2 such as might be the case with some types of production engines, though not all integrated embodiments may be related to a production engine. In some forms the gearbox 54 can be a modified version of a production engine. For example, a M250 gas turbine engine manufactured by Rolls-Royce North America, Inc., Indianapolis, Ind., might be used in the combined cycle power plant 50 in which a gearbox provided with the engine is utilized as the gearbox 54. In some form the gearbox 54 may not be integrated with the gas turbine engine.

The gearbox 54 can include any variety of arrangements to transmit power and/or torque within the power plant 50. In many embodiments, the gearbox 54 generally includes a housing within which are disposed any number of gear types and sizes made from a variety of materials. The gearbox 54 can be configured to provide a gear ratio between an input and an output. In some forms the gearbox 54 can be a transmission which can be an automatic transmission or a manual transmission which in one form is capable of changing a gear ratio. The gearbox 54 can include any number of power modulators such as clutches and the like. If used, the clutches can take a variety of forms such as, but not limited to, wet clutch, dry clutch, multiple plate clutch, centrifugal clutch, cone clutch, slip clutch, and sprag clutch.

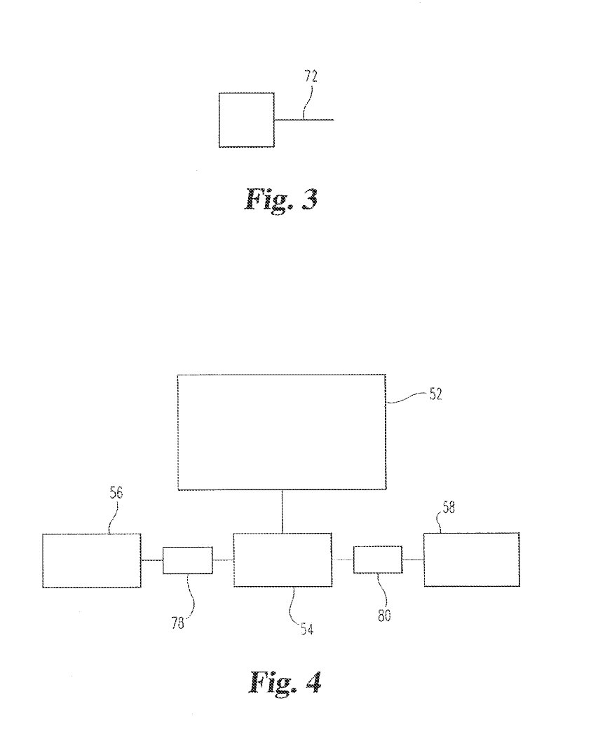

Turning now to FIG. 3, an engine can take the form of a reciprocating or rotary engine. For example, the engine can be a reciprocating piston driven engine, but in other forms the engine can be a rotary engine such as but not limited to a Wankel engine. In one non-limiting embodiment the engine depicted in FIG. 3 is a diesel engine, but other forms are also contemplated herein. The reciprocating or rotary engine can include a crank shaft 72 coupled to a combustion chamber and from which power can be transferred. The reciprocating or rotary engine can also include any number of other shafts coupled to the crank shaft that are capable of transferring power with other devices. In one non-limiting for a drive shaft can be coupled to the crank shaft and from which power can be transferred. For example, the reference numeral 72 can represent a shaft coupled to the crank shaft.

Though the gas turbine engine and diesel engines can be used in the embodiment depicted in FIG. 1, in one particular embodiment the engine 56 is the gas turbine engine and the engine 58 is the diesel engine, both of which were described in various embodiments above.

Referring now to FIGS. 1, 2, and 3, the gearbox 54 can transfer power with the engines 56 and 58 through a variety of energy transfer devices. As depicted in FIG. 1, the gearbox 54 can transfer power with the engine 56 as shown by reference numeral 74 and can transfer power with the engine 58 as shown by reference numeral 76. In one non-limiting embodiment in which the engine 56 is a gas turbine engine, the gearbox 54 can receive and or deliver power to the gas turbine engine through the power take off shaft 70. In another non-limiting embodiment, the gearbox 54 can exchange power with the gas turbine engine through the shaft 68.

In similar fashion, the gearbox 54 can transfer power with the engine 58 as shown by reference numeral 76. In one form in which the engine 58 is a reciprocating piston powered engine the gearbox 54 can transfer power with the crankshaft.

FIG. 4 depicts one embodiment in which the engines 56 and 58 can be selectively coupled to the gearbox 54 through power modulators 78 and 80, respectively. Though the power modulators 78 and 80 are shown in the illustrated embodiment separate from the gearbox 54, in other embodiments, such as some described above, the power modulators 78 and 80 can be integrated within the gearbox 54. The power modulators 78 and 80 can be used to, among other things, selectively engage and disengage the engines 56 and 58 to the gearbox 54. In some forms of the power plant 50 one or both of the power modulators 78 and 80 may be absent even though the embodiment depicted in FIG. 4 shows each of engines 56 and 58 having a power modulator. The power modulators 78 and 80 can be controlled via the controller 60 as will be described further below. The power modulators can be actuated using a variety of techniques. For example, the power modulators 78 and 80 can be actuated using hydraulic power, electric power, mechanical power, as well as other types of power, in addition to any possible combination thereof. To set forth just one non-limiting example, in one form one or both of the power modulators 78 and 80 can be actuated by an electromechanical actuator. In some embodiments the power modulators 78 and 80 can be identical or include a number of similarities, whether size, shape, and/or type of actuation, while in other embodiments the power modulators 78 and 80 are wholly different.

The various embodiments of the power plant 50 can be used to provide a wide variety of power to the vehicle 52. For example, in one phase of operation the power plant 50 can provide power to the vehicle 52 through the engine 56, while in another mode of operation the power plant 50 can provide power to the vehicle 52 through the engine 58. When power is desired and/or needed from the engine 56, the power modulator 78 can be configured such that power is transferred with the engine 56 as shown by reference numeral 74 in FIG. 1. In this state the power modulator 80 can be configured such that power is discouraged from transferring with the engine 58. When power is desired and/or needed from the engine 58, the power modulator 80 can be configured such that power is transferred with the engine 58 as shown by reference numeral 76 in FIG. 1. In this state the power modulator 78 can be configured such that power is discouraged from transferring with the engine 56. In some situations it may be possible that both engines 56 and 58 contribute to power transferred with the vehicle 52.

In still another additional and/or alternative phase of operation, one of the engines can be used to provide starting assist to another of the engines. In some forms the starting assist can be used while power is still provided to the vehicle 52 from the power plant 50. For example, engine 58 could provide starting assist to the engine 56 while the engine 58 is still providing power to the vehicle 52. Power transferred with the vehicle 52, such as powered delivered to the vehicle from the power plant 50, can take the form of mechanical, electrical, or other power. To set forth just one non-limiting example, the engine that provides starting assist to the other engine can at the same time be used to provide motive power to the vehicle 52. Additionally and/or alternatively, the engine that provides starting assist to the other engine can at the same time be used to provide power for internal vehicle needs. Any variety of other configurations are also contemplated herein.

In one particular embodiment in which the power plant 50 includes a gas turbine engine and either a reciprocating or rotary engine, the vehicle 52 can be provided with power from the gas turbine engine during one mode of operation, while the vehicle 52 is provided power from the reciprocating or rotary engine in another mode of operation. The reciprocating or rotary engine can provide power to the vehicle 52 at relatively low power requirements, while the gas turbine engine can provide power to the vehicle at relatively high power requirements. In one non-limiting example, the vehicle 52 can be placed in an idle condition in which the vehicle 52 requires relatively little power, whether mechanical, electrical, and/or otherwise. In the idle condition the reciprocating or rotary engine can provide sufficient power to the vehicle while the power plant is configured to transfer little to no power with the gas turbine engine. In one non-limiting example the gas turbine engine is clutched when the power plant 50 is placed into an idle condition so that the gas turbine engine is decoupled from the vehicle 52. The reciprocating or rotary engine can provide power to the vehicle and, when necessary, provide starting assist to the gas turbine engine. In this mode the power plant 50 can be configured such that the gas turbine engine receives power through the gearbox 54 from the reciprocating or rotary engine to start the gas turbine engine. The reciprocating or rotary engine can also provide power to the vehicle 52 during this period. In one non-limiting form the gas turbine engine can receive power from the reciprocating or rotary engine to the high pressure shaft of the gas turbine engine. The gas turbine engine can receive power through the path from which power is provided to the vehicle 52. For example, the gas turbine engine can have a shaft that serves a dual purpose of communicating power to the vehicle 52 via the gearbox 54 while also serving as the shaft from which power is received from the reciprocating or rotary engine during an assisted start. A clutch can be used to selectively engage or disengage the shaft. In just one alternative embodiment, the gas turbine engine can send and receive power through separate paths. For example, the gas turbine engine can have a shaft from which power is provided to the vehicle 52 via the gear box, and another shaft through which power is received from the reciprocating or rotary engine.

In additional and/or alternative forms and/or modes of operation to any of the embodiments disclosed above, power from both engines 56 and 58 can be summed together to provide a cumulative output when both engines are operating. Such a mode of operation may be provided in some embodiments where the engine 56 is used to provide power to the vehicle 52 while providing starting assist to the engine 58, and once engine 58 is operating the engine 56 can continue to operate to provide the cumulative output. Other forms are also possible where power from the engine 56 is phased out so that a cumulative output is either not provided at all or is provided for only a short duration.

One aspect the present application provides an apparatus comprising a gas turbine engine operable to rotate a first shaft in response to an operation of the gas turbine engine, a variable volume combustion chamber engine operable to rotate a second shaft in response to an operation of the variable volume combustion chamber engine, and a gearbox having a first input connected with the first shaft, a second input connected to the second shaft, and an output selectively coupled with one of the first shaft and the second shaft, wherein the output provides power from the gas turbine engine at a first power output condition, the output provides power from the variable volume combustion chamber engine at a second power output condition, and wherein power from the variable volume combustion chamber engine is used to start the gas turbine engine through the gearbox.

One feature of the present application provides wherein the first power output condition is greater than the second power output condition, wherein the gas turbine engine provides motive power to a ground based vehicle, and wherein the variable volume combustion chamber engine provides idle power to the ground based vehicle.

Another feature of the present application provides wherein the variable volume combustion chamber engine is a diesel engine, and wherein the diesel engine is capable of being used to simultaneously start the gas turbine engine and to provide power to the output.

Yet another feature of the present application provides wherein the first shaft is a power offtake shaft from an engine spool of the gas turbine engine.

Still another feature of the present application provides wherein the second shaft is a driveshaft of the diesel engine, and wherein the gearbox is structured to provide a cumulative power output from both the gas turbine engine and the diesel engine such that the output is coupled simultaneously with the first shaft and the second shaft.

Yet still another feature of the present application provides wherein the variable volume combustion chamber engine can simultaneously provide power to the output and to the gas turbine engine when used to start the gas turbine engine, and which further includes a vehicle coupled with the gearbox, wherein the gearbox provides power output to the vehicle.

A further feature of the present application includes a clutch disposed between the first shaft of the gas turbine engine and the output of the gearbox such that the output can selectively be driven by power received from the gas turbine engine through the first shaft.

A still further feature of the present application includes a clutch disposed between the second shaft of the variable volume combustion chamber engine and the output of the gearbox such that the output can selectively be driven by power received from variable volume combustion chamber engine through the second shaft.

Another aspect the present application provides an apparatus comprising a power device selectively coupled to a cyclical volume combustion engine and a gas turbine engine through a power distributor, the power device capable of selectively receiving power from either of the cyclical volume combustion engine or the gas turbine engine through the power distributor, the power distributor configured to provide power from the cyclical volume combustion engine to accelerate a spool of the gas turbine engine toward an operating condition during the starting of the gas turbine engine.

A feature of the present application provides wherein the power distributor is a gearbox, the power distributor providing idle power and motive power to a ground vehicle.

Another feature of the present application provides wherein the gearbox is integrated with the gas turbine engine, and wherein the cyclical volume combustion engine is capable of burning diesel fuel.

Yet another feature of the present application includes a first power modulator configured to pass power from the cyclical volume combustion engine to the power device in a first state, the cyclical volume combustion engine is a diesel engine, and which further includes a second power modulator structured to pass power from the gas turbine engine to the power device in a second state.

Still yet another feature of the present application provides wherein the first state is a standby state and the second state is an operative power state, the power distributor having a gearing disposed in a housing, and the diesel engine is a piston driven diesel engine.

Still another feature of the present application provides wherein the first power modulator and the second power modulator are clutches, and wherein the power distributor is a gearbox, and wherein the power device is structured to receive power from both the cyclical volume combustion engine and the gas turbine engine through the power distributor.

A further feature of the present application provides wherein the first power modulator is configured to prevent power from passing from the cyclical volume combustion engine to the power device during the second state, and the second power modulator is configured to prevent power from passing from the gas turbine engine to the power device during the first state.

Yet another aspect the present application provides an apparatus comprising a combined cycle power plant having a diesel engine and a gas turbine engine coupled through a gearbox to provide power to a rotatable shaft, and means for starting the gas turbine engine from the diesel engine.

Still another aspect the present application provides a method comprising operating a vehicle having a combined cycle power plant, providing idle power to the vehicle through an engine having a variable combustion chamber in which an expansion of a combustion event drives a crankshaft, generating motive power to the vehicle through a gas turbine engine, and starting the gas turbine engine by routing power from the engine through a gearbox and delivering the power to the gas turbine engine.

A feature of the present application includes mechanically decoupling the gas turbine engine from the vehicle during idle power.

Another feature of the present application includes disengaging the engine when the gas turbine engine is at an operating condition, and wherein the engine is a piston driven engine.

Yet another feature of the present application includes turning a high pressure shaft of the gas turbine engine during the starting, and which further includes providing electrical power to the vehicle from the engine during the starting, wherein the engine includes a reciprocating piston.

While the invention has been illustrated and described in detail in the drawings and foregoing description, the same is to be considered as illustrative and not restrictive in character, it being understood that only the preferred embodiments have been shown and described and that all changes and modifications that come within the spirit of the inventions are desired to be protected. It should be understood that while the use of words such as preferable, preferably, preferred or more preferred utilized in the description above indicate that the feature so described may be more desirable, it nonetheless may not be necessary and embodiments lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

What is claimed is:

1. An apparatus comprising:
a gas turbine engine operable to rotate a first shaft in response to an operation of the gas turbine engine;
a variable volume combustion chamber engine operable to rotate a second shaft in response to an operation of the variable volume combustion chamber engine; and
a gearbox having a first input connected with the first shaft, a second input connected to the second shaft, and an output selectively coupled with one of the first shaft and the second shaft;
wherein the output provides power from the gas turbine engine at a first power output condition, the output provides power from the variable volume combustion chamber engine at a second power output condition; and
wherein power from the variable volume combustion chamber engine is used to start the gas turbine engine through the gearbox.

2. The apparatus of claim 1, wherein the first power output condition is greater than the second power output condition, wherein the gas turbine engine provides motive power to a ground based vehicle, and wherein the variable volume combustion chamber engine provides idle power to the ground based vehicle.

3. The apparatus of claim 1, wherein the variable volume combustion chamber engine is a diesel engine, and wherein the diesel engine is capable of being used to simultaneously start the gas turbine engine and to provide power to the output.

4. The apparatus of claim 3, wherein the first shaft is a power offtake shaft from an engine spool of the gas turbine engine.

5. The apparatus of claim 3, wherein the second shaft is a driveshaft of the diesel engine, and wherein the gearbox is structured to provide a cumulative power output from both the gas turbine engine and the diesel engine such that the output is coupled simultaneously with the first shaft and the second shaft.

6. The apparatus of claim 1, wherein the variable volume combustion chamber engine can simultaneously provide power to the output and to the gas turbine engine when used to start the gas turbine engine, and which further includes a vehicle coupled with the gearbox, wherein the gearbox provides power output to the vehicle.

7. The apparatus of claim 6, which further includes a clutch disposed between the first shaft of the gas turbine engine and the output of the gearbox such that the output can selectively be driven by power received from the gas turbine engine through the first shaft.

8. The apparatus of claim 6, which further includes a clutch disposed between the second shaft of the variable volume combustion chamber engine and the output of the gearbox such that the output can selectively be driven by power received from variable volume combustion chamber engine through the second shaft.

9. An apparatus comprising:
a power device selectively coupled to a cyclical volume combustion engine and a gas turbine engine through a power distributor, the power device capable of selectively receiving power from either of the cyclical volume combustion engine or the gas turbine engine through the power distributor, the power distributor configured to provide power from the cyclical volume combustion engine to accelerate a spool of the gas turbine engine toward an operating condition during the starting of the gas turbine engine.

10. The apparatus of claim 9, wherein the power distributor is a gearbox, the power distributor providing idle power and motive power to a ground vehicle.

11. The apparatus of claim 10, wherein the gearbox is integrated with the gas turbine engine, and wherein the cyclical volume combustion engine is capable of burning diesel fuel.

12. The apparatus of claim 9, which further includes a first power modulator configured to pass power from the cyclical volume combustion engine to the power device in a first state, the cyclical volume combustion engine is a diesel engine, and which further includes a second power modulator structured to pass power from the gas turbine engine to the power device in a second state.

13. The apparatus of claim 12, wherein the first state is a standby state and the second state is an operative power state, the power distributor having a gearing disposed in a housing, and the diesel engine is a piston driven diesel engine.

14. The apparatus of claim 12, wherein the first power modulator and the second power modulator are clutches, wherein the power distributor is a gearbox, and wherein the power device is structured to receive power from both the cyclical volume combustion engine and the gas turbine engine through the power distributor.

15. The apparatus of claim 12, wherein the first power modulator is configured to prevent power from passing from the cyclical volume combustion engine to the power device during the second state, and the second power modulator is configured to prevent power from passing from the gas turbine engine to the power device during the first state.

16. A method comprising:
operating a vehicle having a combined cycle power plant;
providing idle power to the vehicle through an engine having a variable combustion chamber in which an expansion of a combustion event drives a crankshaft;
generating motive power to the vehicle through a gas turbine engine; and
starting the gas turbine engine by routing power from the engine through a gearbox and delivering the power to the gas turbine engine.

17. The method of claim 16, which further includes mechanically decoupling the gas turbine engine from the vehicle during idle power.

18. The method of claim 17, which further includes disengaging the engine when the gas turbine engine is at an operating condition, and wherein the engine is a piston driven engine.

19. The method of claim 16, which further includes turning a high pressure shaft of the gas turbine engine during the starting, and which further includes providing electrical power to the vehicle from the engine during the starting, wherein the engine includes a reciprocating piston.
